(19) United States
(12) Patent Application Publication
(10) Pub. No.: US 2025/0209715 A1
(43) Pub. Date: Jun. 26, 2025

(54) GENERALIZED POSE AND MOTION GENERATION

(71) Applicants: DISNEY ENTERPRISES, INC., Burbank, CA (US); ETH Zürich (Eidgenössische Technische Hochschule Zürich), Zürich (CH)

(72) Inventors: Martin GUAY, Unterengstringen (CH); Dhruv AGRAWAL, Zürich (CH); Jakob Joachim BUHMANN, Zürich (CH); Dominik Tobias BORER, Greifensee (CH)

(21) Appl. No.: 18/975,777

(22) Filed: Dec. 10, 2024

Related U.S. Application Data
(60) Provisional application No. 63/613,664, filed on Dec. 21, 2023.

(51) Int. Cl. G06T 13/80; G06N 3/09; G06T 13/40

(52) U.S. Cl. CPC G06T 13/80; G06N 3/09; G06T 13/40

(57) ABSTRACT

One embodiment of the present invention sets forth a technique for generating a pose for a virtual character. The technique includes determining a graph representation of one or more sets of joints in the virtual character based on (i) constraints associated with one or more joints included in the set(s) of joints and (ii) proportions associated with pairs of joints included in the set(s) of joints. The technique also includes generating, via execution of a neural network, a set of updated node states for the set(s) of joints based on the graph representation. The technique further includes generating, based on the updated node states, one or more output poses that correspond to the set(s) of joints, wherein the output pose(s) include (i) a first set of joint positions for the set(s) of joints, (ii) a first set of joint orientations for the set(s) of joints, and (iii) the proportions.

### CROSS-REFERENCE TO RELATED APPLICATIONS

This application claims the benefit of the U.S. Provisional Application titled “Rig Embeddings for Generalized Neural Inverse Kinematics,” filed on Dec. 21, 2023, and having Ser. No. 63/613,664. The subject matter of this application is hereby incorporated herein by reference in its entirety.

### BACKGROUND

### Field of the Various Embodiments

Embodiments of the present disclosure relate generally to computer vision and machine learning and, more specifically, to generalized pose and motion generation.

### Description of the Related Art

Films, video games, virtual reality (VR) systems, augmented reality (AR) systems, mixed reality (MR) systems, robotics, and/or other types of interactive environments frequently include entities (e.g., characters, robots, etc.) that are posed and/or animated in three-dimensional (3D) space. Traditionally, an entity is posed via a time-consuming, iterative, and laborious process of manually manipulating multiple control handles corresponding to joints (or other parts) of the entity. An inverse kinematics (IK) technique can also be used to compute the positions and orientations of remaining joints (or parts) of the entity that result in the desired configuration of the manipulated joints (or parts). To animate the entity, this manual process is repeated for additional keyframes within a sequence of poses representing movements of the entity, with poses for frames between keyframes generated by interpolating between the keyframes using parametric curves.

More recently, advancements in machine learning and deep learning have led to the development of neural IK models and/or neural motion completion models. The neural IK models include neural networks that leverage full-body correlations learned from large datasets to compute the positions and orientations of un-manipulated joints of the body based on manipulated handles and/or other sparse control inputs. The neural motion completion models include neural networks that leverage full-body correlations learned from large datasets to predict frames that fall between key frames within an animation.

However, conventional neural IK and/or neural motion completion models are limited to generating poses and/or motions for entities with specific sizes and/or characteristics. For example, a given neural IK and/or neural completion model may be trained on a dataset of poses and/or motions for an entity with a specific skeleton size and/or a limited set of identifying attributes (e.g., a gender of the entity). After training is complete, the neural IK and/or neural completion model may be used to generate new poses and/or motions for the same skeleton size and/or set of identifying attributes. Consequently, posing and/or animating a new entity with a different skeleton size and/or a new set of identifying attributes may involve creating a new dataset of poses and/or motions that are specific to the new entity and training a new neural IK and/or neural completion model on the new dataset, which incurs additional time and resource overhead.

As the foregoing illustrates, what is needed in the art are more effective techniques for performing neural IK and/or neural motion completion.

### SUMMARY

One embodiment of the present invention sets forth a technique for generating a pose for a virtual character. The technique includes determining a graph representation of one or more sets of joints in the virtual character based on (i) constraints associated with one or more joints included in the set(s) of joints and (ii) proportions associated with pairs of joints included in the set(s) of joints. The technique also includes generating, via execution of a neural network, a set of updated node states for the set(s) of joints based on the graph representation. The technique further includes generating, based on the updated node states, one or more output poses that correspond to the set(s) of joints, wherein the output pose(s) include (i) a first set of joint positions for the set(s) of joints, (ii) a first set of joint orientations for the set(s) of joints, and (iii) the proportions.

One technical advantage of the disclosed techniques relative to the prior art is the ability to use a single machine learning model to generate new poses and/or motions for different skeleton sizes and/or styles while satisfying sparse constraints and selectively preserving certain aspects of one or more input poses. The disclosed techniques thus reduce time and/or resource overhead over conventional approaches that involve generating a new dataset of poses and/or motions for each skeleton size and/or set of identifying attributes and training a new machine learning model on the new dataset. Further, because the disclosed techniques are capable of generating poses based on a variety of skeleton sizes and/or arbitrary representations of style, the poses may be more diverse, expressive, and/or varied than poses generated via conventional techniques that support a single skeleton size and/or a limited set of identifying attributes. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the training engine and execution engine of FIG. 1, according to various embodiments.

FIG. 3A illustrates an example architecture for the machine learning models of FIG. 2, according to various embodiments.

FIG. 3B illustrates an example graph representing a sequence of poses corresponding to a motion for a virtual character, according to various embodiments.

FIG. 4A illustrates an example output pose for a virtual character, according to various embodiments.

FIG. 4B illustrates an example output pose for a virtual character, according to various embodiments.

FIG. 5 is a flow diagram of method steps for generating one or more poses for a virtual character, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

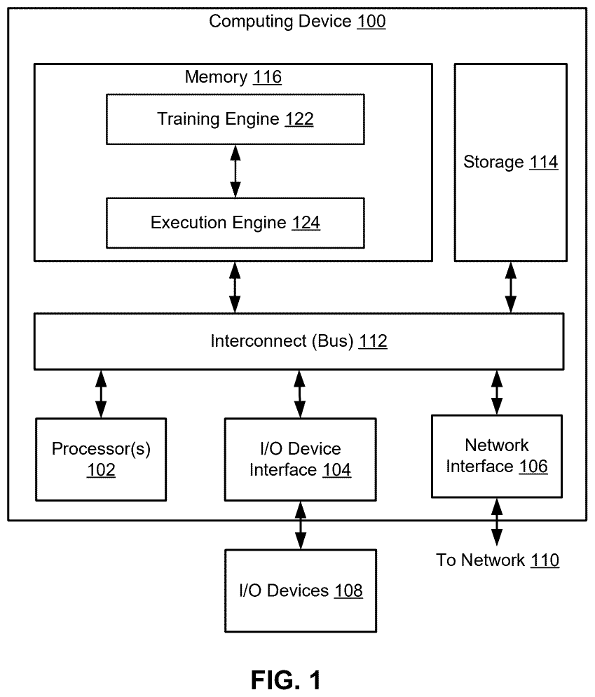

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, training engine 122 and execution engine 124 operate to train and execute one or more machine learning models to perform generalized pose and motion generation. Input into each machine learning model includes a set of proportions that reflect a skeleton size of a corresponding entity. For example, the set of proportions may include vectors and/or distances between pairs of joints that correspond to limbs in the entity. Given the inputted proportions and additional information (e.g., “default” or initial poses, constraints, styles, etc.) related to specific joints in the entity and/or one or more poses of the entity, the machine learning model generates one or more output poses that adhere to the proportions and include joint positions, joint orientations, and/or other joint attributes that reflect the additional information. More specifically, during generalized pose generation, a single output pose is generated based on the inputted proportions and additional information. During generalized motion generation, a sequence of temporally correlated poses representing a motion for the entity is generated based on the inputted proportions and additional information. Training engine 122 and execution engine 124 are described in further detail below.

### Generalized Pose and Motion Generation

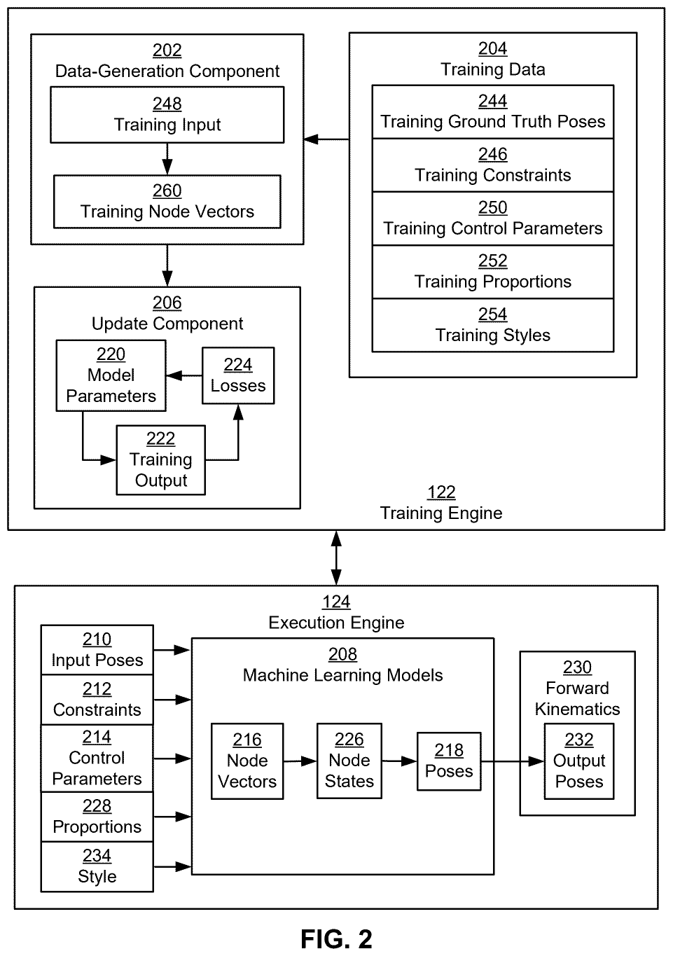

FIG. 2 is a more detailed illustration of training engine 122 and execution engine 124 of FIG. 1, according to various embodiments. As mentioned above, training engine 122 and execution engine 124 operate to train and execute one or more machine learning models 208 to perform generalized pose and motion generation for a virtual character and/or another type of entity. For example, training engine 122 and execution engine 124 may use machine learning models 208 to generate one or more poses 218 for a human, animal, robot, and/or another type of articulated object corresponding to the virtual character.

Each of poses 218 includes a set of two-dimensional (2D) and/or three-dimensional (3D) joint positions, joint orientations, and/or other representations of joints in the articulated object. A skeleton for the articulated object may be defined using a skeleton graph that includes nodes representing joints in the articulated object and spatial edges between pairs of nodes that represent limbs in the articulated object. Additionally, each joint representing a foot (or another part of the articulated object that is capable of contacting the ground) may be associated with a binary ground contact label that is set to 1 when the joint is in contact with the ground and to 0 otherwise.

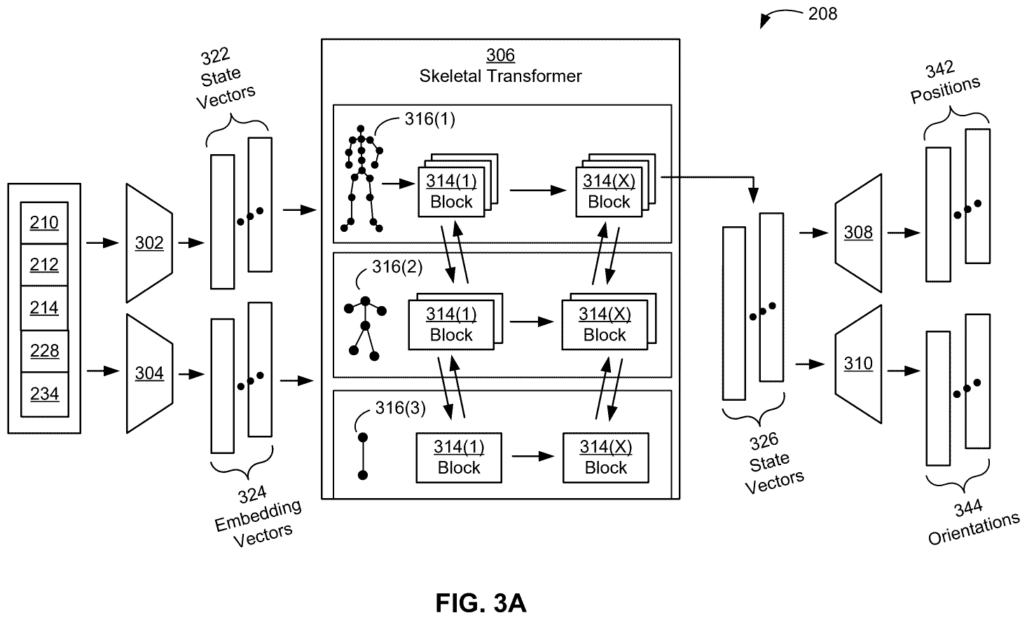

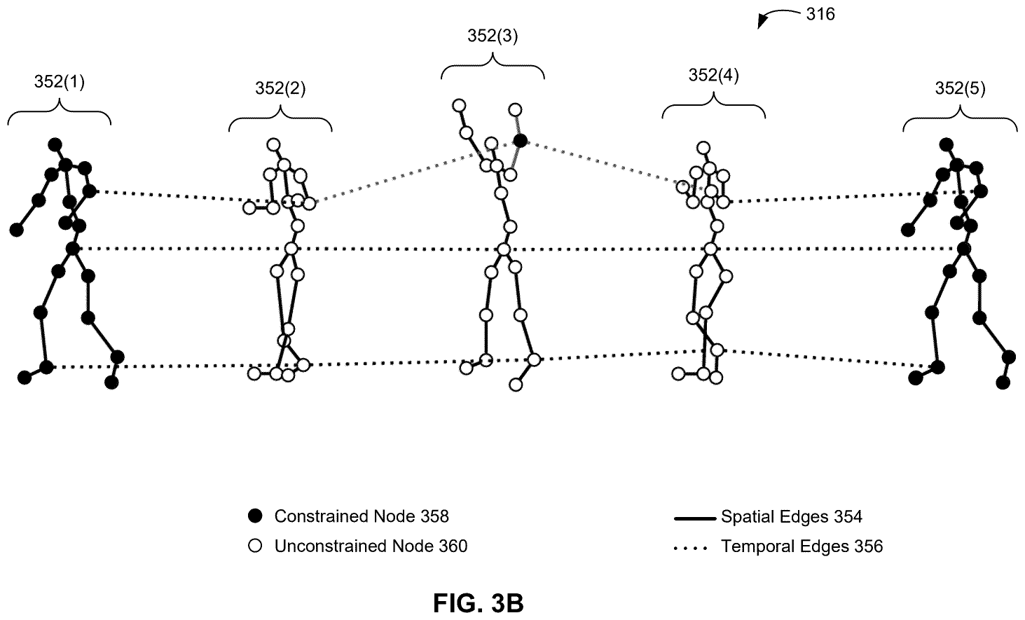

In one or more embodiments, one or more machine learning models 208 generate multiple poses 218 that are ordered within a sequence corresponding to a motion for the articulated object. For example, the motion for a given joint in the virtual character may be defined as {x₀, x₁, . . . , x_{T}}, where xₜ∈{pos,rot} corresponds to a global position and orientation of that joint at time step t. A graph representing a sequence of poses 218 may be defined by creating a copy of the skeleton graph for each temporal position (e.g., time step) in the sequence and adding a temporal edge between xₜ and xₜ₋₁ (for t−1≥0) and/or between xₜ and xₜ₊₁ (for t+1≤T) for each joint in the articulated object, as described in further detail below with respect to FIG. 3B. For example, the graph may include a node ηₜ^{j} for each joint j at each time step t. Thus, for a motion clip with T+1 frames and a skeleton with Na joints, the total number of nodes is (T+1)×Nⱼ.

Machine learning models 208 may also, or instead, be used to generate individual poses 218 that are not temporally correlated with one another. For example, machine learning models 208 may include a neural inverse kinematics (IK) model that is used to generate and/or edit standalone poses 218 for the virtual character. These poses 218 may be used to depict the virtual character (e.g., in images, prints, posters, etc.), as starting points for animating the virtual character, and/or in other tasks involving the virtual character. When machine learning models 208 are used to generate individual poses 218, a single time step t=T=0 may be used, and the graph may include a single skeleton graph for that time step.

As shown in FIG. 2, input into machine leaning models 208 includes one or more input poses 210, a set of constraints 212, a set of control parameters 214, a set of proportions 228, and/or a style 234. Each of input poses 210 includes positions, orientations, and/or other attributes of some or all joints in the virtual character at a corresponding time (e.g., when a sequence of poses 218 corresponding to different time steps in a motion is to be generated). For example, each input pose may include a previously defined pose (or portion of a pose) for the virtual character, as specified by an artist, a posing tool, a neural IK model, a motion capture dataset, and/or a frame in an animation that includes the virtual character.

Constraints 212 include positions, orientations, look-at constraints (e.g., that specify where a face and/or another part of the virtual character should be turned toward), ground contact constraints (e.g., values of the ground contact label that indicate whether or not a corresponding joint contacts the ground at a given time), and/or other types of attributes that are not included in input poses 210 but are to be maintained in poses 218. For example, constraints 212 may be specified for a “sparse” subset of joints in poses 218. These sparse constraints 212 may be specified via user manipulation of control handles for the joint(s) of the virtual character and/or other user-interface elements. Constraints 212 may also, or instead, include a starting pose (e.g., at time t=0), an ending pose (e.g., at time t=T), and/or other whole poses at specific points in time (e.g., at one or more times 0<t<T) that can be used to generate a motion for the virtual character.

In one or more embodiments, input poses 210 include one or more “base poses” that represent a reference for generating poses 218. For example, input poses 210 may include “default” positions, orientations, and/or other attributes of some or all joints in poses 218. Values of these default attributes may be maintained in poses 218, overwritten by constraints 212 for the same joints, and/or modified based on constraints 212 for other joints (e.g., so that individual poses 218 and/or a motion corresponding to a sequence of poses 218 appears natural, realistic, “in character,” etc.).

Input poses 210 may also, or instead, include initial positions, orientations, and/or other attributes of some or all joints in poses 218 that are not included in base poses for the virtual character. These initial attributes may be determined by linearly and/or otherwise interpolating between known positions and/or orientations of joints associated with constraints 212 and/or the base poses. Values of these initial attributes may act as a starting point for generating poses 218. Because these initial attributes do not act as references and/or requirements associated with poses 218, values of these attributes may be more readily modified by machine learning models 208 than values of default attributes in the base pose(s) and/or values of attributes specified in constraints 212.

Control parameters 214 include values that are used to control the generation of poses 218 from input poses 210 and constraints 212. For example, control parameters 214 may include an orientation preservation parameter in the range of [0,1] that specifies the extent to which the orientations of joints in input poses 210 and/or constraints 212 should be preserved. Control parameters 214 may also, or instead, include a position preservation parameter in the range of [0,1] that specifies the extent to which the positions of joints in input poses 210 and/or constraints 212 should be preserved. Values of the orientation preservation parameter and position preservation parameter may be specified for individual joints, sets of joints (e.g., limbs, body segments, upper body, lower body, etc.), all joints in the virtual character, specific points in time, specific ranges of time, and/or other groupings of one or more joints in the virtual character and/or one or more nodes in the graph.

Proportions 228 include sizes and/or dimensions of a skeleton for the virtual character. For example, proportions 228 may include vectors, vector norms, and/or other representations of distances or displacements between pairs of joints that form limbs in the virtual character. Proportions 228 may also, or instead, include positions, orientations, identifiers, and/or other attributes associated with joints in a “canonical” (e.g., T-shape) pose for the virtual character.

Style 234 includes a representation of an identity and/or expression associated with poses 218. For example, style 234 may include an identifier for the virtual character, a textual description (e.g., an emotion, action, posture, character description, personality, etc.), a measure of an attribute (e.g., a value between 0 and 1 that represents a level of “symmetry” or “balance” in poses 218), an image and/or sketch depicting one or more poses 218 and/or a portion of one or more poses 218, and/or other stylistic information associated with poses 218. Style 234 may be specified for individual joints, sets of joints (e.g., limbs, body segments, upper body, lower body, etc.), all joints in the virtual character, specific points in time, specific ranges of time, and/or other groupings of one or more joints in the virtual character and/or one or more nodes in the graph.

Given input poses 210, constraints 212, control parameters 214, proportions 228, and/or style 234, machine learning models 208 generate one or more poses 218. These poses 218 may include positions, orientations, and/or other attributes included in input poses 210 and/or constraints 212. These poses 218 may also, or instead, include orientations, and/or other attributes of joints that are not specified in input poses 210 and/or constraints 212 and/or that differ from those in input poses 210 and/or constraints 212.

As mentioned above, the influence of input poses 210 and/or constraints 212 on one or more attributes of a given joint in poses 218 may be determined based on one or more corresponding control parameters 214. Continuing with the above example, a higher value for the orientation preservation parameter may cause the orientations of a corresponding grouping of joints in input poses 210 and/or constraints 212 to exert a greater influence on the orientations of the same joints within poses 218. Similarly, a higher value for the position preservation parameter may cause the positions of a corresponding grouping of joints in input poses 210 and/or constraints 212 to exert a greater influence on the positions of the same joints within poses 218.

To generate poses 218, one or more machine learning models 208 convert input poses 210, constraints 212, control parameters 214, proportions 228, and/or style 234 into a set of node vectors 216. Machine learning models 208 use a set of neural network blocks and/or other components to convert node vectors 216 into multiple sets of node states 226 for joints in the virtual character. Machine learning models 208 then convert a final set of node states 226 into positions and orientations of the joints within poses 218. The operation of machine learning models 208 is described in further detail below with respect to FIG. 3A.

FIG. 3A illustrates an example architecture for machine learning models 208 of FIG. 2, according to various embodiments. As shown in FIG. 3A, machine learning models 208 include a set of encoders 302 and 304, multiple skeletal transformer 306 layers, and a set of decoders 308 and 310. Each of these components is described in further detail below.

Input into encoders 302 and 304 includes input poses 210, constraints 212, control parameters 214, proportions 228, and style 234. Given this input, encoders 302 and 304 generate a set of state vectors 322 and a set of embedding vectors 324 included in node vectors 216. More specifically, encoder 302 generates a set of state vectors 322 that represent positions, orientations, and/or other attributes of nodes in poses 218 based on input poses 210, constraints 212, and/or proportions 228.

For example, encoder 302 may include a fully connected neural network with one hidden layer and/or another type of machine learning architecture. Encoder 302 may generate, for nodes ηₜ^{j} in the graph representing joints in poses 218, a set of state vectors 322 Nodeₛₜₐₜₑ∈ [symbol] ^{T×N}^{ⱼ}^{×h}. Each state vector has a length of h, and the set of state vectors 322 encodes a concatenation of the positions, orientations, ground contact labels, and proportions 228 for joints represented by the nodes:

$${Node}_{state}^{0} = FCN [ pos , rot , contact , prop ] ( ∈ {ℝ}^{h} ) \qquad ( 1 )$$

In the above equation, pos∈ [symbol] ^{T×N}^{ⱼ}^{×3} is a set of 3D positions for the nodes, rot E [symbol] ^{T×N}^{ⱼ}^{×6} is a set of six-dimensional orientations for the nodes, contact∈ [symbol] ^{T×N}^{ⱼ}^{×1} includes ground contact labels that indicate whether or not the corresponding nodes are in contact with the ground, and prop includes proportions 228 associated with the nodes.

In one or more embodiments, proportions 228 include representations of distances between a given joint and one or more parent joints. For example, proportions 228 may include a vector between a joint and a parent joint to which the joint is connected (e.g., within a directed graph representing a skeleton for the virtual character) and/or a scalar corresponding to the norm of the vector.

Encoder 304 generates a set of embedding vectors 324 that represent identities, constraints 212, control parameters 214, and/or style 234 for joints in poses 218. For example, encoder 304 may include a fully connected neural network with one hidden layer and/or another type of machine learning architecture. Encoder 304 may generate, for a set of nodes ηₜ^{j} in the graph representing poses 218, a corresponding set of embedding vectors 324 Node_{emb}. The calculation of embedding vectors 324 may be represented by the following:

$${J}_{e m b} = {W}_{e m b} {1}_{A} ( [ 1 , 2 , … , {N}_{j} ] ) ( ∈ {ℝ}^{1 \times {N}_{j} \times {h}^{′}} ) \qquad ( 2 )$$

$${T}_{e m b} = P E ( [ 1 , 2 , … , T ] ) ( ∈ {ℝ}^{T \times 1 \times {h}^{′}} ) \qquad ( 3 )$$

$${C}_{e m b} = {W}_{{C}_{e m b}} {1}_{A} ( [ 1 , 2 , … , C ] ) ( ∈ {ℝ}^{h} ) \qquad ( 4 )$$

$${Node}_{e m b} = [ {J}_{e m b} , {T}_{e m b} , {mask}_{*} , {C}_{e m b} ] ( ∈ {ℝ}^{T \times ( {N}_{j} + 1 ) \times h} ) , \qquad ( 5 )$$

In the above equations, W_{emb} and Wc_{emb} are learned linear transformations, 1_{A} is a one-hot encoding function, and PE is a positional encoding. C denotes the number of style 234 classes, distinct characters, and/or other representations of style 234 that can be used to generate poses 218. As an alternative to a linear transformation of a specific style 234, C_{emb} may include an embedding that is derived from a pretrained motion style encoder (e.g., from one or more other poses for the same virtual character and/or a different virtual character), text embedding model (e.g., from a text description of style 234), image embedding model (e.g., from an image and/or sketch depicting style 234), multimodal embedding model (e.g., from one or more data modalities depicting style 234), and/or another type of embedding model. Further, an expansion along appropriate dimensions is performed in Equation 4 to construct embedding vectors 324. Thus, each embedding vector may include a linear embedding J_{emb} of a one-hot encoding representing the identity of joint j, a positional encoding T_{emb} for time t, a mask mask, indicating whether or not the joint is included in input poses 210 and/or constraints 212, and a style embedding C_{emb} that is computed from style 234.

In some embodiments, style 234 is specified for individual poses 218 (e.g., in a sequence of poses 218 corresponding to a motion for the virtual character). In these embodiments, a different style embedding may be generated for each pose (i.e., C_{emb}∈ [symbol] ^{T×1×h}).

Next, skeletal transformer 306 layers use state vectors 322 and embedding vectors 324 to iteratively update node states 226 for the joints. As shown in FIG. 3A, each skeletal transformer 306 layer uses a series of blocks 314(1)-314(X) (each of which is referred to individually herein as block 314) to exchange information among neighboring joints in the virtual character. Blocks 314(1)-314(X) are additionally used to process information associated with three different graphs 316(1), 316(2), and 316(3) (each of which is referred to individually herein as graph 316). Each graph 316 represents a different resolution associated with the skeletal structure of the virtual character. For example, graph 316(1) may represent a joint-level skeleton with one node per joint. Graph 316(2) may represent a limb-level skeleton that pools joints from graph 316(1) into nodes for the hip, spine, and each of the four limbs. Graph 316(3) may represent a body-level skeleton that further reduces nodes from graph 316(2) into one node each for the upper and lower body. When machine learning models 208 are used to generate a time-varying sequence of multiple poses 218 corresponding to a motion for the virtual character, each graph 316 may include (i) multiple copies of the corresponding skeletal structure to represent the sequence and (ii) temporal edges between pairs of nodes representing the same joint at adjacent temporal positions within the sequence, as described in further detail below with respect to FIG. 3B.

FIG. 3B illustrates an example graph 316 representing a sequence of poses corresponding to a motion for a virtual character, according to various embodiments. Graph 316 includes five sets of nodes 352(1)-352(5) (each of which is referred to individually herein as nodes 352) representing five different poses in the sequence. Nodes 352(1) represent a starting input pose (e.g., at t=0), nodes 352(5) represent an ending input pose (e.g., at t=4), and nodes 352(2)-352(4) represent three sets of poses that fall between the starting input pose and the ending input pose (e.g., at t=1 to t=3).

Each solid node in graph 316 corresponds to a constrained node 358 that includes a prespecified position and/or orientation as a corresponding constraint. In the example graph 316 of FIG. 3B, all nodes 352(1) and 352(5) corresponding to the starting and ending input poses 210 are constrained nodes. Further, nodes 352(3) include one constrained node 358 that corresponds to a left elbow in the third frame of the sequence. This constrained node 358 may include a position and/or orientation that are specified via user manipulation of control handles for the joint(s) of the virtual character and/or another mechanism.

Each remaining node in graph 316 is not shown in solid and corresponds to an unconstrained node 360. Positions and/or orientations of these unconstrained nodes may be iteratively updated by skeletal transformer 306 in a way that results in natural motion and satisfies constraints associated with the constrained nodes.

In one or more embodiments, the positions and/or orientations of unconstrained nodes in graph 316 are initialized by interpolating between known positions and/or orientations associated with constrained nodes in graph 316. For example, positions of the unconstrained nodes may be initialized by performing linear interpolation on positions of the constrained nodes. Orientations of the unconstrained nodes may be initialized by performing spherical interpolation on orientations of the constrained nodes. This interpolation results in dense initial positions pos∈ [symbol] ^{T×N}^{ⱼ}^{×3} and orientation rot∈ [symbol] ^{T×N}^{ⱼ}^{×6}. For nodes representing feet (or other joints that can contact the ground), the ground contact label may be set to 0.5 when the ground contact state is unknown and to 0 otherwise, resulting in contact∈ [symbol] ^{T×N}^{ⱼ}^{×1}. To inform machine learning models 208 of constrained nodes in graph 316, mask_{*}∈ [symbol] ^{T×N}^{ⱼ}^{×1} is generated as a concatenation of masks denoting position, orientation, and ground contact constraints (i.e., *∈{pos,rot, ontact}).

Within each set of nodes 352(1)-352(5), solid lines between pairs of nodes denote spatial edges 354 that represent limbs formed between the corresponding joints. Dotted lines between pairs of nodes denote temporal edges 356 that represent temporal relationships between the same joints in adjacent poses. Nodes 352(1)-352(5), spatial edges 354, and temporal edges 356 in graph 316 are used by attention mechanisms in skeletal transformer 306 to perform message passing in the spatial and temporal neighborhood of each joint. For example, the constrained node representing the left elbow in the third frame may attend to spatial neighbors of the shoulder and the wrist in the third frame and to temporal neighbors of the elbow in the second and the fourth frame via the attention mechanisms. The process may be repeated for additional graphs 316 representing other resolutions associated with the skeletal structure of the virtual character and/or multiple layers of skeletal transformer 306 prior to generating poses 218.

In some embodiments, machine learning models 208 operate on graph 316 to generate a time-varying sequence of poses 218 during a motion authoring and/or motion editing task. In the motion authoring task, the motion generated by machine learning models 208 is conditioned on constraints 212 that include positions and/or orientations of a subset of nodes 352 within the sequence and/or specific poses within the sequence (e.g., the first and last pose in the sequence). For example, machine learning models may generate a sequence of poses 218 that depicts natural motion in the unconstrained nodes while satisfying constraints 212 associated with each constrained node 358.

During motion editing, the motion generated by machine learning models 208 is conditioned on a base motion (e.g., a preexisting sequence of input poses 210 for the entity) associated with each unconstrained node 358 and one or more constraints 212 associated with each constrained node 360. For example, machine learning models 208 may generate a sequence of poses 218 that preserves certain aspects of the base motion while satisfying constraints 212.

Returning to the discussion of FIG. 3A, in one or more embodiments, skeletal transformer 306 includes a graph transformer neural network that uses attention mechanisms in blocks 314 and a number of message-passing steps to exchange information among neighboring joints in each graph 316. The output of a given skeletal transformer 306 layer includes a set of state vectors 326 representing node states 226 of nodes in the corresponding graph 316. These state vectors 326 may be inputted into the next skeletal transformer 306 layer, and the process may be repeated using the next skeletal transformer 306 layer until a set of state vectors 326 representing final node states 226 is outputted by the last skeletal transformer 306 layer.

Each block 314 in a given skeletal transformer 306 layer includes a skeletal multi-head attention layer, a feedforward neural network, and a residual connection. The skeletal multi-head attention layer splits matrices for queries, keys, and values into multiple sub-matrices. Each sub-matrix of a given matrix is passed through a different attention head to compute an attention score, and multiple attention scores produced by the attention heads in the skeletal multi-head attention are combined into a single attention score. The output of the skeletal multi-head attention for a given node is then calculated as a sum of values for neighboring nodes in a given graph 316 that are weighted by the corresponding attention scores.

When there are no intermediate constraints 212 between the starting and ending input poses 210 (e.g., in a sequence of poses 218 corresponding to a motion for the virtual character), information flows from constrained nodes in the starting and ending input poses 210 to unconstrained nodes in poses between the starting and ending input poses 210 due to the local structure of the graph. When intermediate constraints 212 are specified, the propagation of information across poses can be accelerated due to shorter windows with no information.

Because the state of the constrained nodes is provided as input, skeletal transformer 306 layers update the unconstrained node states to regress the full motion in a latent space. Within a given block 314, embedding vectors 324 are used as keys K and queries Q, and state vectors 322 are used as values V. Therefore, the operation of each skeletal transformer 306 layer i is given by:

$${Node}_{{state}^{′}}^{i} = MHA ( K = Q = {Node}_{e m b} , V = {Node}_{state}^{i - 1} ) \qquad ( 6 )$$

$${Node}_{state}^{i} = FCN ( {Node}_{{state}^{′}}^{i} ) + {Node}_{state}^{i - 1} \qquad ( 7 )$$

In the above equations, Node state represents state vectors 326 after the i^{th} skeletal transformer 306 layer, MHA denotes the skeletal multi-head attention, and FCN denotes the fully connected network.

Each skeletal transformer 306 layer uses multiple layers of graphs 316 representing different resolutions associated with the skeletal structure of the virtual character to propagate information across the joints of the virtual character. In particular, skeletal transformer 306 uses a first block 314(1) to perform a first set of message-passing steps that exchange information among nodes in graph 316(1). After the first set of message-passing steps is complete, skeletal transformer 306 uses the output of the first set of message-passing steps and the same block 314(1) to perform a second set of message-passing steps that exchange information among nodes in graph 316(2). After the second set of message-passing steps is complete, skeletal transformer 306 uses the output of the second set of message-passing steps and the same block 314(1) to perform a third set of message-passing steps that exchange information among nodes in graph 316(3). Skeletal transformer 306 additionally uses the output of the third set of message-passing steps and block 314(1) to perform a fourth set of message-passing steps that exchange information among nodes in graph 316(2). Skeletal transformer 306 then uses the output of the fourth set of message-passing steps and block 314(1) to perform a fifth set of message-passing steps that exchange information among nodes in graph 316(1). Skeletal transformer 306 then repeats the process with additional blocks 314 until state vectors 326 representing final node states are outputted by block 314(X).

In some embodiments, blocks 314 and graphs 316 reduce the number of message-passing steps performed to converge on poses 218. For example, skeletal transformer 306 may perform six message-passing steps to exchange information among nodes in graph 316(1), four message-passing steps to exchange information among nodes in graphs 316(2), and two message-passing steps to exchange information among nodes in graph 316(3) instead of a much larger number of message-passing steps to exchange information among nodes in a single high-resolution graph (e.g., graph 316(1)).

Skeletal transformer 306 may additionally use various pooling and/or un-pooling functions to mix information between graphs 316 associated with different resolutions. For example, skeletal transformer 306 may use masked inter-level Multi-Head Attention blocks 314 to propagate node states 226 associated with nodes from a given graph 316 to nodes in a different graph 316. The mask associated with these blocks 314 may be designed so that a given node can attend only to itself and corresponding nodes from a different resolution (e.g., one or more nodes in a lower resolution with which the given node is associated, a set of nodes in a higher resolution that are pooled into the given node, etc.). These blocks 314 additionally allow skeletal transformer 306 to dynamically assign weights to information from nodes in different layers.

At the beginning of the message passing process, only constrained joints hold information that should be propagated throughout the skeletal structure. Consequently, skeletal transformer 306 can operate using a node-level mask Mₖⁱ that indicates which nodes hold new information in layer i after block k. At the start of the message passing process, Mᵢ₌₀^{joint} is the same as mask_{*}, and the limb-level and body-level masks are defined using the following:

$${M}_{t = 0}^{l} [ j ] = \{ \begin{matrix}1 & if ∃ Joint {j}_{0} , s . t . {j}_{0} ∈ j and {c}_{IC}^{{j}_{0}} = 1 \\ 0 & Otherwise\end{matrix} \qquad ( 8 )$$

In other words, a given node in a lower-resolution graph 316 is determined to hold information that should be propagated if the given node is associated with another node in a higher-resolution graph 316 that holds new information.

At the end of every block 314, the mask for layer l∈{joint, limb, body} is updated using the following:

$${M}_{t}^{l} = {A}^{l} {M}_{t - 1}^{l} \qquad ( 9 )$$

In the above equation, A^{l} is the adjacency matrix for nodes in graph 316 of layer l. Each entry in the mask includes an upper bound of 1 that represents full neighbor influence and prevents message passing from increasing for nodes with degree greater than 1.

State vectors 326 outputted by the last skeletal transformer 306 layer are processed by a set of decoders 308 and 310. More specifically, decoder 308 converts state vectors 326 into positions 342 of the corresponding joints in poses 218, and decoder 310 converts state vectors 326 into orientations 344 of the corresponding joints in poses 218. Like encoders 302 and 304, decoders 308 and 310 may include fully connected networks with one hidden layer and/or other machine learning architectures.

Returning to the discussion of FIG. 2, training engine 122 trains machine learning models 208 using training data 204 that includes training ground truth poses 244, training constraints 246, training control parameters 250, training proportions 252, and/or training styles 254. Training ground truth poses 244 include individual poses associated with various virtual characters and/or sequences of poses that depict motion in the virtual characters. For example, training ground truth poses 244 may include individual poses and/or sequences of poses that are generated using a motion capture technique. These poses may depict a person, animal, robot, and/or another type of articulated object walking, jogging, running, turning, spinning, dancing, strafing, waving, climbing, descending, crouching, hopping, jumping, dodging, skipping, interacting with an object, lying down, sitting, stretching, and/or engaging in another type of action, a combination of actions, and/or a sequence of actions. These poses may be retargeted to a skeleton for the virtual character that includes a certain set of joints and/or training proportions 252 that specify a size of the skeleton. Training ground truth poses 244 may also, or instead, include poses that are generated and/or edited by artists, animators, and/or other users. Training ground truth poses 244 may also, or instead, be generated synthetically using computer vision, computer graphics, animation, machine learning, and/or other techniques.

Like constraints 212, training constraints 246 include positions, orientations, ground contact labels, and/or other types of attributes to be applied to specific joints within a given pose and/or at specific times within a sequence of poses. Training constraints 246 may be user-specified, randomly generated (e.g., by sampling attributes of joints from each training sequence with a certain range of probabilities), and/or otherwise determined.

Training control parameters 250 include values of the orientation preservation parameter, pose preservation parameter, and/or other control parameters 214 that specify the extent to which the positions, orientations, and/or other attributes of joints in training ground truth poses 244 and/or training constraints 246 should be preserved. Training control parameters 250 may be sampled from uniform distributions of corresponding ranges of values and/or otherwise determined.

As mentioned above, training proportions 252 may specify sizes and/or dimensions of various skeletons. For example, training proportions 252 may include scalar distances between pairs of joints that form limbs in the virtual character. Training proportions 252 may also, or instead, include positions, orientations, identifiers, and/or other attributes associated with joints in a “canonical” (e.g., T-shape) pose for the virtual character. Training proportions 252 may be generated from physical scans, motion capture data, and/or other “real world” data collected from humans and/or other entities; specified by artists, animators, and/or other users; generated synthetically; and/or augmented (e.g., by adding noise to distances between limbs and/or attributes of joints with an uncertainty parameter, lengthening and/or shortening certain limbs, etc.). When training proportions 252 are augmented for sequences of training ground truth poses 244 representing motion, retargeting techniques may be used to “correct” for issues such as legs that extend through the ground.

As with style 234, training styles 254 include identities and/or expressions associated with training ground truth poses 244. For example, training styles 254 may include identifiers for virtual characters, textual descriptions (e.g., emotions, actions, postures, character descriptions, personalities, etc.), measures of various attributes (e.g., a value between 0 and 1 that represents a level of “symmetry” or “balance” in poses 218), images and/or sketches depicting one or more representative poses and/or portions of one or more representative poses, and/or other stylistic information. Training styles 254 may be specified for individual joints, sets of joints (e.g., limbs, body segments, upper body, lower body, etc.), all joints in the virtual character, specific points in time, specific ranges of time, and/or other groupings of one or more joints in the virtual character and/or one or more nodes in the graph.

A data-generation component 202 in training engine 122 converts a data sample that includes one or more training ground truth poses 244, training constraints 246, training control parameters 250, training proportions 252, and/or training styles 254 into a corresponding set of training input 248. For example, data-generation component 202 may generate a graph-based representation (e.g., graph 316 of FIG. 3A) of an individual pose and/or a sequence of poses. The graph-based representation may include per-node initial positions, orientations, ground contact labels, masks denoting training constraints 246, and/or training proportions 252.

Data-generation component 202 also generates a set of training node vectors 260 from each set of training input. Continuing with the above example, data-generation component 202 may use the techniques described above with respect to FIG. 3A to convert the graph-based representation of poses in the training sequence into training node vectors 260 that include per-node state vectors 322 and embedding vectors 324.

An update component 206 in training engine 122 trains machine learning models 208 using training node vectors 260 generated by data-generation component 202 from the corresponding sets of training input 248. More specifically, update component 206 inputs each set of training node vectors 260 into machine learning models 208. Update component 206 also executes machine learning models 208 to produce corresponding training output 222 that represents a predicted motion for the virtual character. Update component 206 computes one or more losses 224 using training output 222 and training ground truth poses 244, training constraints 246, training control parameters 250, training proportions 252, and/or training styles 254 used to generate that set of training node vectors 260. Update component 206 then uses a training technique (e.g., gradient descent and backpropagation) to update model parameters 220 of machine learning models 208 in a way that reduces losses 224. Update component 206 repeats the process with additional training node vectors 260 and training output 222 until model parameters 220 converge, losses 224 fall below a threshold, and/or another condition indicating that training of machine learning models 208 is complete is met.

In some embodiments, data-generation component 202 and update component 206 uses different types of training input 248 and losses 224 to train machine learning models 208 on different tasks, including (but not limited to) a pose editing task, a motion authoring task, and/or a motion editing task. To train machine learning models 208 on the pose editing task, data-generation component 202 generates training input 248 that includes a graph-based representation of a single pose. Within the graph-based representation, initial positions, orientations, look-ats, and/or ground contact labels may include values from training constraints 246 for the corresponding nodes and values from a corresponding training ground truth pose for remaining unconstrained nodes. Data-generation component 202 then converts this training input 248 into training node vectors 260, as described above.

Losses 224 that are used to train machine learning models on the pose editing task include a pose preservation loss that is computed between a given training base pose and a corresponding set of training output 222 generated by machine learning models 208 from that training base pose. For example, the pose preservation loss may include the following representation:

$${ℒ}_{p p} ( y , {y}^{′} , R , {R}^{′} ) = {‖ {C}_{F K} ⊗ ⊗ ( y - {y}^{′} ) ‖}_{2}^{2} + arccos [ ( t r ( {C}_{IK} ⊗ ⊗ {R}^{′T} R ) - 1 ) / 2 ] \qquad ( 10 )$$

In the above equation, [symbol] _{App} denotes the pose preservation loss, y and R denote joint positions and orientations in the training base pose, respectively, and y′ and R′ denote joint positions and orientations in training output 222, respectively. The pose preservation loss is computed by summing a first term that corresponds to an £2 loss between y and y′ and a second term that corresponds to an orientation geodesic loss between R and R′. The term [symbol] corresponds to the inverse of the mask denoting training constraints 246 and is used to avoid penalizing joints associated with training constraints 246. The orientation preservation parameters C_{FK} and pose preservation parameters C_{IK} are used to weight the pose preservation loss according to the amount of the training base pose to be preserved in training output 222.

In one or more embodiments, the pose preservation loss is combined with additional losses into an overall loss [symbol] :

$$ℒ = {ℒ}_{p o s} + {ℒ}_{o r ient} + {ℒ}_{l o o k - at} + {λ}_{p p} {ℒ}_{p p} \qquad ( 11 )$$

In the above equation, [symbol] ₚₒₛ=∥ŷ−y′∥₂² corresponds to an [symbol] ² loss computed between joint positions y′ in training output 222 and joint positions ŷ for the same joints as specified in training constraints 246, and [symbol] ₒᵣᵢₑₙₜ=arccos[(tr (R′^{T}\hat{R})−1)/2] corresponds to a geodesic loss that is computed between joint orientations R′ in training output 222 and joint orientations R for the same joints as specified in training constraints 246. [symbol] ₗₒₒₖ₋ₐₜ=arccos[ [symbol] ·Ĝⱼ¹³ dⱼ] corresponds to a look-at loss geodesic loss that is computed using a unit-length vector [symbol] pointing at the external target in world space, a direction vector dⱼ for a joint, a predicted global transform matrix Ĝⱼ, and a global predicted look-at direction represented by Ĝⱼ¹³ dⱼ, where Ĝⱼ¹³=Ĝⱼ [1:3,1:3].

To train machine learning models 208 on the motion authoring task, data-generation component 202 generates training input 248 that includes a graph-based representation of a sequence of poses. Within the graph-based representation, initial positions, orientations, and ground contact labels may include values from training constraints 246 for the corresponding nodes and interpolated values for the remaining unconstrained nodes. Data-generation component 202 then converts this training input 248 into training node vectors 260, as described above.

Losses 224 that are used to train machine learning models 208 on the motion authoring task include the following representation:

$$ℒ = {ℒ}_{R} + {ℒ}_{H} + {ℒ}_{C} \qquad ( 12 )$$

In the above equation, [symbol] _{R} denotes a reconstruction loss, [symbol] _{H} denotes a constraint loss, and [symbol] _{C} denotes a ground contact loss.

In some embodiments, the reconstruction loss supervises the predicted local orientations [symbol] , global positions [symbol] and global orientations [symbol] based on corresponding ground truth values rotₗ, pos_{g}, and rot_{g}, respectively, from training ground truth poses 244. This supervision includes an L² loss that is computed between the predicted positions and corresponding ground truth positions and a geodesic loss that measures the angle on the great arc between a predicted orientation and a corresponding ground truth orientation. The reconstruction loss includes the following formulation:

$$G e o ( R , \hat{R} ) = arccos [ ( t r ( {\hat{R}}^{T} R ) - 1 ) / 2 ] \qquad ( 13 )$$

$${ℒ}_{p o s} = {‖ - {pos}_{g} ‖}_{2} \qquad ( 14 )$$

$${ℒ}_{rot} = G e o ( r o {t}_{l} , ) + G e o ( r o {t}_{g} , ) \qquad ( 15 )$$

$${ℒ}_{R} = {ω}_{p o s} {ℒ}_{p o s} + {ω}_{rot} {ℒ}_{rot} \qquad ( 16 )$$

In the above equations, R and \hat{R} are rotation matrices, and ω_{*} is a scalar control parameter that weights the corresponding loss term according to the amount of the type of ground truth value (e.g., position, orientation, etc.) to be preserved in training output 222.

In one or more embodiments, the constraint loss measures the loss on the constrained positions and orientations associated with training ground truth poses 244 and/or training constraints 246. This can be applied using mask_{*} as follows:

$${ℒ}_{IK} = {‖ {mask}_{p o s} ⊗ ( - po {s}_{g} ) ‖}_{2} \qquad ( 17 )$$

$${ℒ}_{F K} = {mask}_{rot} ⊗ Geo ( ro {t}_{g} , ) \qquad ( 18 )$$

$${ℒ}_{H} = {ω}_{IK} {ℒ}_{IK} + {ω}_{F K} {ℒ}_{F K} \qquad ( 19 )$$

where ⊗ is an element-wise multiplication.

In some embodiments, the ground contact loss supervises the ground contact labels and corresponding foot velocities:

$${ℒ}_{C} = {‖ - contact ‖}_{2} + {‖ ⊗ ‖}_{2} \qquad ( 20 )$$

The above equation includes a first L² norm between the predicted ground contact labels and corresponding ground truth values and a second L² norm of the element-wise product of the predicted ground contact labels and the corresponding predicted velocities [symbol] . Consequently, the ground contact loss aims to minimize the error between the predicted and ground truth ground contact labels while also minimizing the velocities of nodes with predicted ground contact labels that are greater than 0.

To train machine learning models 208 on the motion editing task, data-generation component 202 samples a set of training constraints 246 from a sequence of training ground truth poses 244. For example, data-generation component 202 may generate training constraints 246 by sampling attributes of joints from the sequence with a certain range of probabilities. Data-generation component 202 also samples a different set of base motion constraints from the same sequence of training ground truth poses 244. For example, data-generation component 202 may generate the base motion constraints by sampling attributes of joints from the sequence with a certain range of probabilities, which may be the same as or differ from the range of probabilities used to sample training constraints 246.

Data-generation component 202 uses the base motion constraints to generate a training base motion. For example, data-generation component 202 may input the base motion constraints into one or more machine learning models 208 that have been trained on a motion authoring task. In response to the inputted base motion constraints, machine learning models 208 may generate a realistic training base motion that includes a subset of the high-frequency details of the sequence of training ground truth poses 244. Data-generation component 202 may also, or instead, use interpolation techniques, other machine learning models, and/or other types of techniques to convert the base motion constraints into a training base motion.

Data-generation component 202 additionally generates training input 248 that includes a graph-based representation of poses in the training base motion. Data-generation component 202 may also overwrite positions, orientations, and/or other attributes of one or more nodes in the graph-based representation with corresponding positions, orientations, and/or other attributes specified in a corresponding set of training constraints 246. Data-generation component 202 then converts this training input 248 into training node vectors 260, as described above.

Losses 224 that are used to train machine learning models 208 on the motion editing task include the following representation:

$${ℒ}_{M E} = {ℒ}_{R} + {ℒ}_{H} + {ℒ}_{C} + {ω}_{B M} {ℒ}_{B M} \qquad ( 21 )$$

In the above equation, [symbol] _{BM} is a base motion preservation loss that is computed using the following:

$${ℒ}_{B M} = {‖ {ω}_{M E} ⊗ ( p o {s}_{M E} - p o {s}_{S B} ) ‖}_{2} + G e o ( {ω}_{M E} ⊗ r o {t}_{M E} , {ω}_{M E} ⊗ ro {t}_{S B} ) \qquad ( 22 )$$

More specifically, pos_{ME} and rot_{ME} are predicted world space positions and orientations generated by machine learning models 208, and pos_{SB} and rot_{SB} are the positions and orientations from a corresponding training base motion.

In Equation 22, ω_{ME} is a control parameter that is applied as a weight mask to nodes in temporal positions associated with constraints. For example, ω_{ME} may be generated as a frame-wise weighting. During this frame-wise weighting, a mask m is initially set to 1 for each temporal position that includes at least one constraint and to 0 otherwise. An average filter is then applied over m with a kernel window of a certain size, so that nodes with temporal positions that are closer to constraints are penalized less for not matching the training base motion.

In Equation 21, ω_{BM} is a control parameter that specifies the relative weight of the base motion preservation loss with respect to the reconstruction loss, constraint loss, and ground contact loss. By tuning the kernel window associated with ω_{ME} and ω_{BM}, machine learning models 208 can be trained to preserve base motion more strongly and/or to satisfy training constraints 246 better.

After training of machine learning models 208 on a certain task (e.g., pose editing, motion authoring, motion editing, etc.) is complete, execution engine 124 uses the trained machine learning models 208 to generate one or more new poses 218 for the virtual character, where each set of new poses 218 is derived from a corresponding set of input poses 210, constraints 212, control parameters 214, proportions 228, and/or style 234. For example, execution engine 124 may use a set of encoders in machine learning models 208 to convert a given set of input poses 210, constraints 212, control parameters 214, proportions 228, and/or style 234 into a corresponding set of node vectors 216. Execution engine 124 may use a graph neural network and/or attention mechanisms in machine learning models 208 to iteratively update a set of node states 226 for joints in poses 218 based on node vectors 216 and a hierarchy of resolutions associated with a skeletal structure for the virtual character. Execution engine 124 may then use a set of decoders in machine learning models 208 to convert a final set of node states 226 into one or more corresponding poses 218.

When machine learning models 208 are used to perform a pose editing and/or motion editing task, poses 218 may preserve and/or combine attributes of joints from input poses 210 and constraints 212 based on control parameters 214 that represent the level of influence input poses 210 and/or constraints 212 should have on those attributes. When machine learning models 208 are used to perform a motion authoring task, poses 218 may include attributes from constraints 212 for the corresponding nodes and attributes for unconstrained nodes that result in a natural motion for the virtual character. Poses 218 may additionally reflect proportions 228 of limbs in the virtual character and/or an inputted style 234 for the virtual character.

After a set of one or more poses 218 is generated by one or more machine learning models 208, execution engine 124 uses forward kinematics 230 to convert poses 218 into final output poses 232 that enforce predefined bone lengths for the virtual character. For example, execution engine 124 may apply forward kinematics 230 to each of poses 218 as a sequence of rigid transformations that use per-joint offset vectors to update the positions and/or orientations of joints in that pose based on positions and orientations of the joints in a resting pose for the virtual character. Each offset vector may represent a bone length constraint for the corresponding joint and specify a displacement of the joint with respect to a parent joint when the rotation of the joint is zero.

Execution engine 124 may additionally use output poses 232 to generate corresponding representations of the virtual character. For example, execution engine 124 may output a skeleton, rendering, and/or another visual representation of the virtual character in each output pose. Execution engine 124 may also, or instead, incorporate output poses 232 into one or more frames of an animation of the virtual character.

In one or more embodiments, values of input poses 210, constraints 212, control parameters 214, proportions 228, and/or style 234 are iteratively updated within a user interface and/or workflow for performing interactive pose editing, motion authoring, and/or motion editing associated with the virtual character. For example, an artist, animator, and/or another user may import, into the workflow, one or more “default” poses, manually generated poses, motion capture data, and/or other previously defined poses as an initial set of input poses 210 for the virtual character. The user may also use control handles and/or other user-interface elements to specify constraints 212 on the positions, orientations, and/or other attributes of one or more joints in the virtual character. The user may further specify control parameters 214 that indicate the degree to which joint positions and/or orientations in input poses 210 and/or constraints 212 should be preserved (e.g., due to a lack of relationship between input poses 210 and a target pose to be attained), proportions 228 associated with a skeleton for the virtual character and/or individual output poses 232, and/or a given style 234 associated with output poses 232. The user may then trigger the execution of one or more machine learning models 208 within the workflow to generate a corresponding set of output poses 232 that incorporates input poses 210, constraints 212, control parameters 214, proportions 228, and/or style 234. The user may repeat the process with the generated output poses 232 as new input poses 210 and/or using updated constraints 212. As the generated set of output poses 232 is iteratively refined, the user may update control parameters 214 and/or adjust constraints 212 to reduce the deviation of output poses 232 from input poses 210 and/or constraints 212.

Because each of machine learning models 208 is capable of generating output that reflects a set of proportions 228 and/or a style 234 associated with a virtual character, the same machine learning model can be used within a pose editing, motion authoring, and/or motion editing workflow to generate output poses 232 and/or motions for different virtual characters, proportions 228, and/or styles. Consequently, machine learning models 208 may generate a more diverse range of output poses 232 and/or motions than conventional approaches that use different machine learning models to generate poses for different skeleton sizes and/or character attributes. Machine learning models 208 may additionally reduce latency and/or resource overhead over conventional approaches that train a separate machine learning model to generate poses and/or motions for each skeleton size and/or set of character attributes.

While machine learning models 208 have been described above with respect to a specific architecture and losses 224, it will be appreciated that input poses 210, constraints 212, control parameters 214, proportions 228, and/or style 234 can be incorporated into other machine learning architectures and/or training techniques for performing pose and/or motion generation. For example, machine learning models 208 may include one or more convolutional neural networks, graph neural networks, fully connected neural networks, transformer neural networks, recurrent neural networks, residual neural networks, embedding models, and/or other types of machine learning architectures. In another example, machine learning models 208 may be trained using reconstruction losses, adversarial losses, perceptual losses, and/or other types of supervised and/or unsupervised losses.

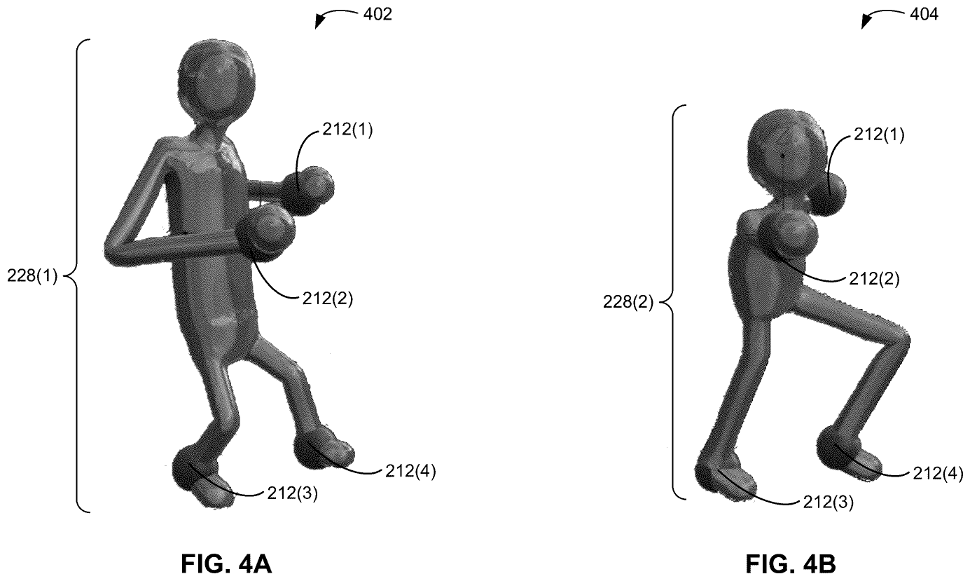

Additionally, proportions 228 can be varied across temporally related poses 218 to animate bone lengths and/or limbs in an animation and/or motion for a given virtual character. For example, proportions 228 may be incrementally changed across poses 218 corresponding to frames in an animation to produce an “elastic limbs” effect in the virtual character. Varying proportions 228 across temporally related poses 218 is described in further detail below with respect to FIGS. 4A-4B.

FIG. 4A illustrates an example output pose 402 for a virtual character, according to various embodiments. As shown in FIG. 4A, output pose 402 is generated based on a set of four constraints 212(1)-212(4) and a set of proportions 228(1) associated with the virtual character. For example, output pose 402 may be generated by one or more machine learning models 208 during a pose editing, motion authoring, and/or motion editing task from constraints 212(1)-212(4), proportions 228(1), one or more input poses 210, one or more control parameters 214, and/or one or more representations of style 234.

Output pose 402 includes positions, orientations, and/or other attributes specified in constraints 212(1)-212(4) for the corresponding joints (e.g., the hands and feet of the virtual character). Output pose 402 also includes positions, orientations, and/or other attributes of additional joints that are not associated with constraints 212(1)-212(4) (e.g., head, neck, shoulders, spine, hips, elbows, knees, etc.). These attributes may be determined based on corresponding attributes from the input pose(s), control parameters 214 associated with the additional joints, style 234, and/or proportions 228(1). For example, attributes of unconstrained joints in output pose 402 may adhere to proportions 228(1) for the virtual character while reflecting a given style 234 and/or input pose(s) associated with the virtual character.

FIG. 4B illustrates an example output pose 404 for a virtual character, according to various embodiments. More specifically, FIG. 4B illustrates a new output pose 404 that is generated for the virtual character of FIG. 4A from the same constraints 212(1)-212(4) and a different set of proportions 228(2).

As shown in FIG. 4B, proportions 228(2) include shorter arms, a shorter, torso, and longer legs in the virtual character. Because constraints 212(1)-214(4) are the same (i.e., the positions and/or orientations of the hands and feet are the same in both FIGS. 4A and 4B), attributes of unconstrained joints in the virtual character are updated in output pose 404 to reflect the different proportions 228(2). For example, output pose 404 may be more “crouched” or “hunched” than output pose 402 to adhere to proportions 228(2) while maintaining the positions and/or orientations of the constrained hands and feet.

Further, different sets of proportions 228(1) and 228(2) may be determined for different output poses 232 to generate various effects and/or type of motion in the virtual character. For example, an “elastic limbs” effect in the virtual character may be generated by gradually lengthening the arms and torso and gradually shortening the legs across a sequence of output poses 232 from output pose 402 to output pose 404.

Returning to the discussion of FIG. 2, in some embodiments, output poses 232 are used to generate animations, virtual characters, and/or other content in an immersive environment, such as (but not limited to) a VR, AR, and/or MR environment. This content can depict virtual worlds that can be experienced by any number of users synchronously and persistently, while providing continuity of data such as (but not limited to) personal identity, user history, entitlements, possession, and/or payments. It is noted that this content can include a hybrid of traditional audiovisual content and fully immersive VR, AR, and/or MR experiences, such as interactive video.

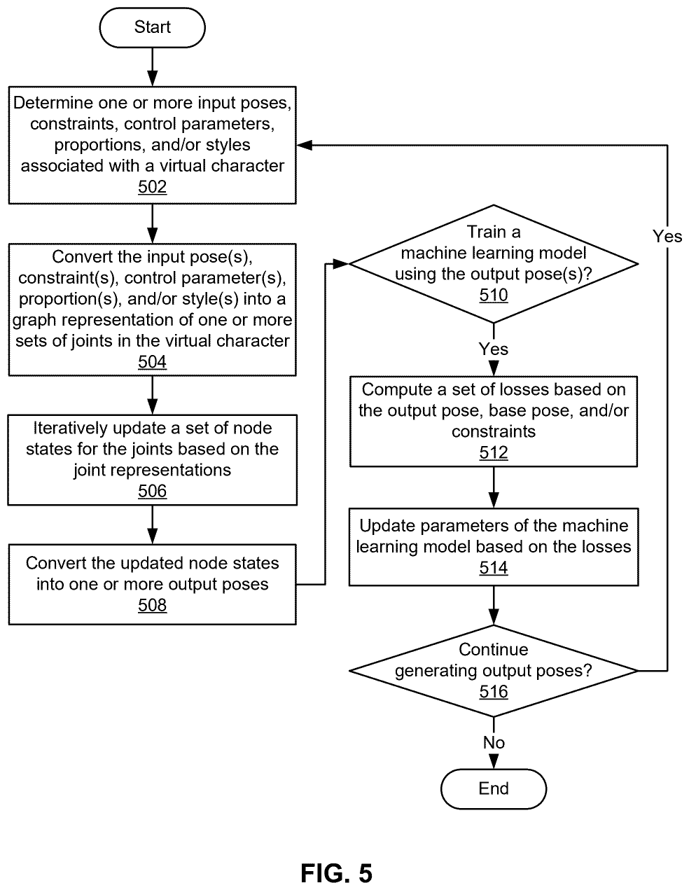

FIG. 5 is a flow diagram of method steps for generating one or more poses for a virtual character, according to various embodiments. Although the method steps are described in conjunction with the systems of FIGS. 1-2, persons skilled in the art will understand that any system configured to perform the method steps in any order falls within the scope of the present disclosure.

As shown, in step 502, training engine 122 and/or execution engine 124 determine one or more input poses, constraints, control parameters, proportions, and/or styles associated with a virtual character. For example, training engine 122 and/or execution engine 124 may receive the input pose(s) as one or more “default,” predefined, and/or initialized pose(s) for the virtual character. Training engine 122 and/or execution engine 124 may also obtain constraints related to the positions, orientations, look-ats, and/or ground contact labels of one or more joints and/or one or more poses in the virtual character. Training engine 122 and/or execution engine 124 may additionally select and/or receive the control parameters as values that indicate the extent to which the position and/or orientation of joints in the input pose(s) and/or constraint(s) should be preserved. Training engine 122 and/or execution engine 124 may further receive the proportions as vectors and/or scalar distances between pairs of joints corresponding to limbs in the virtual character. Training engine 122 and/or execution engine 124 may receive the style as an identifier for the virtual character, a textual description (e.g., an emotion, action, posture, character description, personality, etc.), a measure of an attribute (e.g., a value between 0 and 1 that represents a level of “symmetry” or “balance” in poses for the virtual character), an image and/or sketch depicting one or more poses and/or a portion of one or more poses, and/or other stylistic information related to an identity or expression associated with the virtual character.

In step 504, training engine 122 and/or execution engine 124 convert the input pose(s), constraint(s), control parameter(s), proportion(s), and/or style(s) into a graph representation of one or more sets of joints in the virtual character. For example, the graph representation may include a set of nodes that represent different joints in a skeleton for the virtual character and spatial edges between pairs of nodes that correspond to limbs in the skeleton. When a sequence of poses corresponding to a motion for the virtual character is to be generated, the set of nodes may be duplicated for each temporal position (e.g., time step) in the sequence, and the graph may include temporal edges between nodes representing the same joint at adjacent temporal positions within the sequence. Training engine 122 and/or execution engine 124 may use one or more encoder neural networks to generate, for each node in the graph representation, an embedding vector that encodes a joint identifier for the joint, a temporal position of the joint within the sequence of poses, a set of masks that indicate whether or not the joint is constrained, and/or the style(s). Training engine 122 and/or execution engine 124 may also use the encoder neural network(s) to generate, for each node in the graph representation, a node vector that encodes the position, orientation, ground contact state, proportions associated with the node (e.g., vectors and/or distances between the node and one or more parent nodes), and/or other attributes of the corresponding joint at the corresponding time. The positions, orientations, ground contact labels may include values from nodes associated with the input pose(s) and/or constraints and interpolated values for the remaining nodes.

In step 506, training engine 122 and/or execution engine 124 iteratively update a set of node states for the joints based on the joint representations. For example, training engine 122 and/or execution engine 124 may use a graph transformer neural network to perform message passing among the nodes in the graph representation and/or between the nodes and one or more lower-resolution representations of the skeletal structure of the virtual character. Each message-passing step may involve using a block in the graph transformer neural network to update the node states based on attention scores and/or node states from a previous message-passing step.

In step 508, training engine 122 and/or execution engine 124 convert the updated node states into one or more output poses. Continuing with the above example, training engine 122 and/or execution engine 124 may use one or more decoder neural networks to decode final node states outputted by the graph transformer neural network into positions and orientations of the corresponding joints. Training engine 122 and/or execution engine 124 may additionally perform a forward kinematics step that updates the positions and/or orientations of the joints in a way that enforces bone lengths in the virtual character. Training engine 122 and/or execution engine 124 may further output a rendering, skeleton, set of motion curves, animation, and/or another visualization of the output pose(s) within a user interface.

In step 510, training engine 122 and/or execution engine 124 determine whether or not to train a machine learning model using the output pose(s). For example, training engine 122 and/or execution engine 124 may determine that the encoder, graph transformer, and/or decoder neural networks are to be trained using the output pose(s) if the output pose(s) are generated during a training process associated with the encoder, graph transformer, and/or decoder neural networks; the output pose(s) are flagged as unnatural, unrealistic, and/or otherwise suboptimal by a user; and/or another condition associated with training of the encoder, graph transformer, and/or decoder neural networks is met.

If training engine 122 and/or execution engine 124 determine that the machine learning model is to be trained using the output pose(s), training engine 122 performs step 512, in which training engine 122 computes a set of losses based on the output pose(s), input pose(s), and/or constraint(s). When the machine learning model is trained on a pose editing task that generates a single output pose, these losses may be used to preserve the input pose(s) and/or constraint(s) in the output pose. When the machine learning model is trained on a motion authoring task, the losses may include a reconstruction loss between positions and orientations of joints in a sequence of output poses and corresponding ground truth positions and orientations of the joints, a constraint loss between positions and orientations of joints in the output poses that are associated with the constraint(s) and corresponding values in the constraint(s), and/or a ground contact loss that minimizes the error between predicted and ground truth ground contact labels for certain joints while also minimizing the velocities of joints with predicted ground contact labels that are greater than 0. When the machine learning model is trained on a motion editing task, the losses may include the same losses as those for the motion authoring task and/or an additional base motion preservation loss between positions and orientations of joints in the output poses and corresponding values in a base motion.

In step 514, training engine 122 updates parameters of the machine learning model based on the losses. For example, training engine 122 could use a training technique (e.g., gradient descent and backpropagation) to update neural network weights of the encoder, graph transformer, and/or decoder neural networks in a way that reduces the loss(es).

If training engine 122 and/or execution engine 124 determine in step 510 that the output pose should not be used to train the machine learning model, training engine 122 and/or execution engine 124 skip steps 512 and 514 and proceed to step 516 from step 510.

In step 516, training engine 122 and/or execution engine 124 determine whether or not to continue generating output poses. For example, training engine 122 and/or execution engine 124 may determine that output poses should continue to be generated during training of the machine learning model, during execution of a workflow for posing and/or animating the virtual character, and/or in another environment or setting in which poses for the virtual character are to be generated. If training engine 122 and/or execution engine 124 determine that output poses should continue to be generated for the virtual character, training engine 122 and/or execution engine 124 repeat steps 502, 504, 506, 508, 510, 512, and/or 514 to continue generating new output poses for the virtual character and/or training the virtual character using the new output poses. Training engine 122 and/or execution engine 124 also repeat step 516 to determine whether or not to continue generating output poses. During step 516, training engine 122 and/or execution engine 124 may determine that output poses should not continue to be generated once training of the machine learning model is complete, execution of the workflow for posing and/or animating the virtual character is discontinued, and/or another condition is met.

In sum, the disclosed techniques train and execute one or more machine learning models to perform generalized pose and motion generation. Input into each machine learning model includes a set of proportions that reflect a skeleton size of a corresponding entity. For example, the set of proportions may include distances between pairs of joints that correspond to limbs in the entity. Given the inputted proportions and additional information (e.g., input poses, constraints, styles, etc.) related to specific joints in the entity and/or one or more poses of the entity, the machine learning model generates one or more output poses that adhere to the proportions and include joint positions, joint orientations, and/or other joint attributes that reflect the additional information. More specifically, during generalized pose generation, a single output pose is generated based on the inputted proportions and additional information. During generalized motion generation, a sequence of temporally correlated poses representing a motion for the entity is generated based on the inputted proportions and additional information. These output pose(s) may be used in a pose editing task, in which positions, orientations, and/or other attributes of individual joints in the entity are updated while preserving aspects of an input pose; a motion authoring task, in which a sequence of poses corresponding to a motion for the entity is conditioned on constraints that include positions and/or orientations of a subset of joints within the sequence and/or specific poses within the sequence; and/or a motion editing task, in which a sequence of poses corresponding to a motion is conditioned on a base motion for the entity (e.g., a preexisting sequence of input poses for the entity) and a set of sparse constraints.

The machine learning model includes a set of encoder neural network layers that encode identities, positions, orientations, proportions, styles, constraints, and/or other attributes of joints in a skeletal structure for each output pose. The machine learning model also includes a graph transformer neural network with a cross-layer attention mechanism that simultaneously performs message passing at multiple resolutions (e.g., joint level, limb level, body level, etc.) associated with the skeletal structure within a given pose and/or via temporal relationships that link poses across a given sequence (e.g., based on the encoded identities, spatial and temporal positions, and orientations). The machine learning model further includes a set of decoder neural network layers that decode the final encodings outputted by the graph neural network into positions and orientations of the joints. A forward kinematics step is used to convert the positions and orientations outputted by the machine learning model into updated positions and orientations of the joints that are consistent with the proportions in the skeletal structure.

One technical advantage of the disclosed techniques relative to the prior art is the ability to use a single machine learning model to generate new poses and/or motions for different skeleton sizes and/or styles while satisfying sparse constraints and selectively preserving certain aspects of one or more input poses. The disclosed techniques thus reduce time and/or resource overhead over conventional approaches that involve generating a new dataset of poses and/or motions for each skeleton size and/or set of identifying attributes and training a new machine learning model on the new dataset. Further, because the disclosed techniques are capable of generating poses based on a variety of skeleton sizes and/or arbitrary representations of style, the poses may be more diverse, expressive, and/or varied than poses generated via conventional techniques that support a single skeleton size and/or a limited set of identifying attributes. These technical advantages provide one or more technological improvements over prior art approaches.

1. In some embodiments, a computer-implemented method for generating a pose for a virtual character comprises determining a graph representation of one or more sets of joints in the virtual character based on (i) a set of constraints associated with one or more joints included in the one or more sets of joints and (ii) a set of proportions associated with pairs of joints included in the one or more sets of joints; generating, via execution of a first neural network, a set of updated node states for the one or more sets of joints based on the graph representation; and generating, based on the set of updated node states, one or more output poses that correspond to the one or more sets of joints, wherein the one or more output poses include (i) a first set of joint positions for the one or more sets of joints, (ii) a first set of joint orientations for the one or more sets of joints, and (iii) the set of proportions.

2. The computer-implemented method of clause 1, further comprising training the first neural network using (i) a first loss that is computed between the first set of joint positions and a second set of joint positions included in one or more ground truth poses and (ii) a second loss that is computed between the first set of joint orientations and a second set of joint orientations included in the one or more ground truth poses.

3. The computer-implemented method of any of clauses 1-2, further comprising training the first neural network based on one or more additional losses associated with the set of constraints.

4. The computer-implemented method of any of clauses 1-3, further comprising sampling the set of proportions; and generating the one or more ground truth poses based on the sampled set of proportions and the set of constraints prior to training the first neural network.

5. The computer-implemented method of any of clauses 1-4, wherein determining the graph representation comprises generating, via execution of a second neural network, a first set of embeddings included in the graph representation based on at least one of (i) a set of identities for the one or more sets of joints, (ii) a temporal position of each set of joints included in the one or more sets of joints, or (iii) the set of constraints; determining, based on at least one of one or more input poses associated with the virtual character or the set of constraints, (i) a second set of joint positions for the one or more sets of joints and (ii) a second set of joint orientations for the one or more sets of joints; and generating, via execution of a third neural network, a second set of embeddings included in the graph representation based on the second set of joint positions, the second set of joint orientations, and the set of proportions.

6. The computer-implemented method of any of clauses 1-5, wherein the first set of embeddings is further generated based on a style for the virtual character.

7. The computer-implemented method of any of clauses 1-6, wherein the style comprises at least one of an identifier, a textual description, an image, or an attribute associated with the one or more output poses.

8. The computer-implemented method of any of clauses 1-7, wherein the set of constraints comprises at least one of a starting pose, an ending pose, a positional constraint, an orientation constraint, a look-at constraint, or a ground contact constraint.

9. The computer-implemented method of any of clauses 1-8, wherein the first neural network comprises a set of cross-layer attention blocks associated with a plurality of resolutions for a skeletal structure of the virtual character.

10. The computer-implemented method of any of clauses 1-9, wherein the set of proportions comprises a set of distances between the pairs of joints.

11. In some embodiments, one or more non-transitory computer-readable media store instructions that, when executed by one or more processors, cause the one or more processors to perform operations comprising determining a graph representation of one or more sets of joints in a virtual character based on (i) a set of constraints associated with one or more joints included in the one or more sets of joints and (ii) a set of proportions associated with pairs of joints included in the one or more sets of joints; generating, via execution of a first neural network, a set of updated node states for the one or more sets of joints based on the graph representation; and generating, based on the set of updated node states, one or more output poses that correspond to the one or more sets of joints, wherein the one or more output poses include (i) a first set of joint positions for the one or more sets of joints, (ii) a first set of joint orientations for the one or more sets of joints, and (iii) the set of proportions.

12. The one or more non-transitory computer-readable media of clause 11, wherein the operations further comprise training the first neural network using (i) a first loss associated with one or more base poses for the virtual character and (ii) a second loss associated with the set of constraints.

13. The one or more non-transitory computer-readable media of any of clauses 11-12, wherein the operations further comprise sampling the set of proportions associated with the one or more sets of joints; generating the one or more base poses based on the sampled set of proportions and an additional set of constraints; and further determining the graph representation based on the one or more base poses prior to training the first neural network.

14. The one or more non-transitory computer-readable media of any of clauses 11-13, wherein determining the graph representation comprises generating a set of embedding vectors included in the graph representation based on at least one of (i) a set of identities for the one or more sets of joints, (ii) a temporal position of each set of joints included in the one or more sets of joints, or (iii) the set of constraints; and determining a set of state vectors included in the graph representation based on (i) one or more input poses associated with the virtual character, (ii) the set of constraints, and (iii) the set of proportions.

15. The one or more non-transitory computer-readable media of any of clauses 11-14, wherein converting the graph representation into the set of updated node states comprises computing a set of attention scores based on the graph representation; and generating the set of updated node states based on the set of attention scores.

16. The one or more non-transitory computer-readable media of any of clauses 11-15, wherein the set of attention scores is further computed based on a set of masks associated with the set of constraints.

17. The one or more non-transitory computer-readable media of any of clauses 11-16, wherein generating the one or more output poses comprises converting, via execution of one or more additional neural networks, the set of updated node states into the first set of joint positions and the first set of joint orientations; and updating the first set of joint positions and the first set of joint orientations based on a rest pose for the virtual character and a forward kinematics technique.

18. The one or more non-transitory computer-readable media of any of clauses 11-17, wherein the one or more output poses are further generated based on at least one of an identifier for the virtual character, a textual description of a style associated with the virtual character, or an attribute associated with the one or more output poses.

19. The one or more non-transitory computer-readable media of any of clauses 11-18, wherein the graph representation comprises a plurality of nodes corresponding to the one or more sets of joints, a plurality of spatial edges between a first subset of node pairs included in the plurality of nodes, and a plurality of temporal edges between a second subset of node pairs included in the plurality of nodes.

20. In some embodiments, a system comprises one or more memories that store instructions, and one or more processors that are coupled to the one or more memories and, when executing the instructions, are configured to perform operations comprising determining a graph representation of one or more sets of joints in a virtual character based on (i) one or more input poses for the virtual character, (ii) a set of constraints associated with one or more joints included in the one or more sets of joints, (iii) a set of proportions associated with pairs of joints included in the one or more sets of joints, and (iv) a style associated with the virtual character; generating, via execution of a first neural network, a set of updated node states for the one or more sets of joints based on the graph representation; and generating, based on the set of updated node states, one or more output poses that correspond to the one or more sets of joints, wherein the one or more output poses include (i) a first set of joint positions for the one or more sets of joints, (ii) a first set of joint orientations for the one or more sets of joints, and (iii) the set of proportions.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a pose for a virtual character, comprising:
determining a graph representation of one or more sets of joints in the virtual character based on (i) a set of constraints associated with one or more joints included in the one or more sets of joints and (ii) a set of proportions associated with pairs of joints included in the one or more sets of joints;
generating, via execution of a first neural network, a set of updated node states for the one or more sets of joints based on the graph representation; and
generating, based on the set of updated node states, one or more output poses that correspond to the one or more sets of joints, wherein the one or more output poses include (i) a first set of joint positions for the one or more sets of joints, (ii) a first set of joint orientations for the one or more sets of joints, and (iii) the set of proportions.

2. The computer-implemented method of claim 1, further comprising training the first neural network using (i) a first loss that is computed between the first set of joint positions and a second set of joint positions included in one or more ground truth poses and (ii) a second loss that is computed between the first set of joint orientations and a second set of joint orientations included in the one or more ground truth poses.

3. The computer-implemented method of claim 2, further comprising training the first neural network based on one or more additional losses associated with the set of constraints.

4. The computer-implemented method of claim 2, further comprising:
sampling the set of proportions; and
generating the one or more ground truth poses based on the sampled set of proportions and the set of constraints prior to training the first neural network.

5. The computer-implemented method of claim 1, wherein determining the graph representation comprises:
generating, via execution of a second neural network, a first set of embeddings included in the graph representation based on at least one of (i) a set of identities for the one or more sets of joints, (ii) a temporal position of each set of joints included in the one or more sets of joints, or (iii) the set of constraints;
determining, based on at least one of one or more input poses associated with the virtual character or the set of constraints, (i) a second set of joint positions for the one or more sets of joints and (ii) a second set of joint orientations for the one or more sets of joints; and
generating, via execution of a third neural network, a second set of embeddings included in the graph representation based on the second set of joint positions, the second set of joint orientations, and the set of proportions.

6. The computer-implemented method of claim 5, wherein the first set of embeddings is further generated based on a style for the virtual character.

7. The computer-implemented method of claim 6, wherein the style comprises at least one of an identifier, a textual description, an image, or an attribute associated with the one or more output poses.

8. The computer-implemented method of claim 1, wherein the set of constraints comprises at least one of a starting pose, an ending pose, a positional constraint, an orientation constraint, a look-at constraint, or a ground contact constraint.

9. The computer-implemented method of claim 1, wherein the first neural network comprises a set of cross-layer attention blocks associated with a plurality of resolutions for a skeletal structure of the virtual character.

10. The computer-implemented method of claim 1, wherein the set of proportions comprises a set of distances between the pairs of joints.

11. One or more non-transitory computer-readable media storing instructions that, when executed by one or more processors, cause the one or more processors to perform operations comprising:
determining a graph representation of one or more sets of joints in a virtual character based on (i) a set of constraints associated with one or more joints included in the one or more sets of joints and (ii) a set of proportions associated with pairs of joints included in the one or more sets of joints;
generating, via execution of a first neural network, a set of updated node states for the one or more sets of joints based on the graph representation; and
generating, based on the set of updated node states, one or more output poses that correspond to the one or more sets of joints, wherein the one or more output poses include (i) a first set of joint positions for the one or more sets of joints, (ii) a first set of joint orientations for the one or more sets of joints, and (iii) the set of proportions.

12. The one or more non-transitory computer-readable media of claim 11, wherein the operations further comprise training the first neural network using (i) a first loss associated with one or more base poses for the virtual character and (ii) a second loss associated with the set of constraints.

13. The one or more non-transitory computer-readable media of claim 12, wherein the operations further comprise:
sampling the set of proportions associated with the one or more sets of joints;
generating the one or more base poses based on the sampled set of proportions and an additional set of constraints; and
further determining the graph representation based on the one or more base poses prior to training the first neural network.

14. The one or more non-transitory computer-readable media of claim 11, wherein determining the graph representation comprises:
generating a set of embedding vectors included in the graph representation based on at least one of (i) a set of identities for the one or more sets of joints, (ii) a temporal position of each set of joints included in the one or more sets of joints, or (iii) the set of constraints; and
determining a set of state vectors included in the graph representation based on (i) one or more input poses associated with the virtual character, (ii) the set of constraints, and (iii) the set of proportions.

15. The one or more non-transitory computer-readable media of claim 11, wherein converting the graph representation into the set of updated node states comprises:
computing a set of attention scores based on the graph representation; and
generating the set of updated node states based on the set of attention scores.

16. The one or more non-transitory computer-readable media of claim 15, wherein the set of attention scores is further computed based on a set of masks associated with the set of constraints.

17. The one or more non-transitory computer-readable media of claim 11, wherein generating the one or more output poses comprises:
converting, via execution of one or more additional neural networks, the set of updated node states into the first set of joint positions and the first set of joint orientations; and
updating the first set of joint positions and the first set of joint orientations based on a rest pose for the virtual character and a forward kinematics technique.

18. The one or more non-transitory computer-readable media of claim 11, wherein the one or more output poses are further generated based on at least one of an identifier for the virtual character, a textual description of a style associated with the virtual character, or an attribute associated with the one or more output poses.

19. The one or more non-transitory computer-readable media of claim 11, wherein the graph representation comprises a plurality of nodes corresponding to the one or more sets of joints, a plurality of spatial edges between a first subset of node pairs included in the plurality of nodes, and a plurality of temporal edges between a second subset of node pairs included in the plurality of nodes.

20. A system, comprising:
one or more memories that store instructions, and
one or more processors that are coupled to the one or more memories and, when executing the instructions, are configured to perform operations comprising:
determining a graph representation of one or more sets of joints in a virtual character based on (i) one or more input poses for the virtual character, (ii) a set of constraints associated with one or more joints included in the one or more sets of joints, (iii) a set of proportions associated with pairs of joints included in the one or more sets of joints, and (iv) a style associated with the virtual character;
generating, via execution of a first neural network, a set of updated node states for the one or more sets of joints based on the graph representation; and
generating, based on the set of updated node states, one or more output poses that correspond to the one or more sets of joints, wherein the one or more output poses include (i) a first set of joint positions for the one or more sets of joints, (ii) a first set of joint orientations for the one or more sets of joints, and (iii) the set of proportions.
